(19) United States
(12) Patent Application Publication
(10) Pub. No.: US 2006/0212833 A1
(43) Pub. Date: Sep. 21, 2006

(54) Radial, three-dimensional hierarchical file system view

(75) Inventors: Matthew William Gallagher, Leichhardt (AU); Colin Eric Druitt, Marsfield (AU); Bin Liao, Cheltenham (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/302,422

(22) Filed: Dec. 14, 2005

(30) Foreign Application Priority Data
Dec. 20, 2004 (AU) 2004240229

(51) Int. Cl. G06F 3/00

(52) U.S. Cl. 715/848

(57) ABSTRACT

Disclosed is a method of displaying a hierarchical file structure. The method determines a visual arrangement (100) of containers (102) which reflects a hierarchical relationship of the file structure. A concentric curved shape is then formed representing each container in the file structure and files within the containers, the curved shape having a geometry and location according to the determined visual arrangement. A viewpoint (600) is then established for the curved shape which is substantially radial thereto and allows viewing from a root container of the file structure towards one or more child containers of the file structure. The curved shape is then rendered, relative to the viewpoint, to a display (2114). Desirably, the files within a container (102) are represented as a tower (104) in the curved shape.

### CROSS REFERENCE TO RELATED PATENT APPLICATIONS

This application claims the right of priority under 35 U.S.C. § 119 based on Australian Patent Application No. 2004240229, filed 20 Dec. 2004, which is incorporated by reference herein in its entirety as if fully set forth herein.

### COPYRIGHT NOTICE

This patent specification contains material that is subject to copyright protection. The copyright owner has no objection to the reproduction of this patent specification or related materials from associated patent office files for the purposes of review, but otherwise reserves all copyright whatsoever.

### FIELD OF THE INVENTION

The present invention relates to visualization models and human-computer interaction and, in particular, to the display, arrangement and navigation of hierarchical structures such as file system folder trees.

### BACKGROUND

There are many ways to represent hierarchical structures. One classic example is the typical company organisational chart, which starts with the company head at the top and branches at each level downwards into divisions, sections, groups and teams.

Visually, this type of structure becomes difficult to display, on an electronic display device because the structure can quickly expand to a large width as the levels are traversed downwards. Printing the structure in a “landscape” format may ameliorate this problem provided the paper size is sufficiently large. However such obviates dynamic editing or other manipulation of the structure.

Computer-based hierarchical structures, of which the nested folders of the file system are one of the best known examples, have the same display difficulties. To manage the expansion of such structures, the most common approach is to utilize a collapsible/expandable tree. This is well exemplified by the file-tree in Windows Explorer™ graphical user interface which is part of the Windows™ operating system manufactured by Microsoft Corp. With such a tree approach, deeper levels of hierarchy are not displayed until needed. Further, each deeper level of hierarchy is displayed vertically, rather than horizontally, in contrast to the typical organisational chart. This allows the display to expand primarily in just one direction (downwards) which simplifies the navigation of the tree, by affording substantially unidirectional navigation, and is somewhat akin to the printing in landscape fashion.

Unfortunately, this tree structure, while widespread, has many significant limitations. The tree expands very quickly in the vertical direction, requiring significant vertical scrolling if access is required at different points in the tree. The collapsed-by-default nature of the tree hides everything at lower levels of the hierarchy. The arrangement also gives equal weight (in terms of visual size and placement) to each node in the hierarchy (in Windows Explorer™ these nodes are folders), irrespective of their actual significance (the number, type and/or size of files that the folders contain).

Different approaches have attempted to provide better arrangements that remain functional and easy to use. ZoomBrowser™, marketed by Canon Inc., is a photograph viewer application which traverses the file-system to find and view digital photos, and is the subject of U.S. Pat. No. 6,545,687 granted Apr. 8, 2003 to Scott et. al. In a “Zoom Mode”, the ZoomBrowser™ application provides a view of the hierarchy where the top level is a (primary) rectangle occupying the entire view area and all nodes on the next level are (secondary) rectangles nested within the primary rectangle. Nodes on subsequent levels of hierarchy are nested within their respective parent rectangles. At a file level, a thumbnail or modified thumbnail representation of each photograph is displayed relative to the size of the rectangle of that level, the number of rectangles in the hierarchy and the number of files in that rectangle, thereby affording the user the opportunity to perceive the content and number of files in the hierarchy. This is an improvement on the file-tree approach in that it allows multiple levels of the hierarchy to be viewed by default and further visually emphasises the containment relationship of the hierarchy. It has the limitation though that containment rectangles very quickly become very small between levels of the hierarchy. This problem can worsen when folder content (photos) are displayed within the visual structure. There is also no weighting to each folder based on significance (number of photos contained).

Filelight is a KDE Linux disk usage viewer that adds weighting to a file tree. Instead of orthogonal arrangements, Filelight arranges the file hierarchy as a pie-chart with the top level of the hierarchy visible as arcs in the inner-most ring and each ring moving outwards displaying the contained folders nestled within their parent arcs. Each arc at every level of the hierarchy occupies a percentage of the full circle which reflects the total data size of that folder and all its children relative to the total amount of data in all folders in the hierarchy. This arrangement as a few strengths: it emphasises the containment relationships, and it weights each folder based on its significance (amount of disk space used). Unfortunately, it is poorly suited to displaying elements contained within each folder (like files) since the flat circle arrangement leaves no space to place extra visual elements.

Another radial arrangement with some with weighting is described in “A Focus+Context Technique Based on Hyperbolic Geometry for Visualizing Large Hierarchies”; Lamping, J.; Rao, R.; Pirolli, P.; ACM Conference on Human Factors in Computing Systems (CHI '95), Denver, Colo. (1995). This view has significant ability to navigate very deep hierarchies very quickly. This view loses navigability by being less rigorous and regular than Filelight and still suffers from a lack of ability to show elements within each node of the hierarchy.

Three-dimensional arrangements are another approach to arranging hierarchies. The driving motivations behind these approaches are normally to use the extra dimensionality to provide better structures that more accurately describe the underlying data structures. There is also the desire to have something in 3D simply because it is “cool”. Both are perfectly acceptable aims but unfortunately, many efforts in 3D have lost the functionality and ease of navigation and interaction of their 2D counterparts.

The paper “Cone Trees: Animated 3D Visualizations of Hierarchical Information”; Robertson, G. G.; Mackinlay, J. D.; Card, S. K.; ACM Conference on Human Factors in Computing Systems (CHI '91) pp. 189-194. (1991) discloses a number of arrangements in the early 1990's including the “cone-tree”. Unfortunately, this was simply taking the old “organisational chart” arrangement and padding it out into 3D. Without strict approaches to navigation and approaches to reducing occlusion and maximising visibility, this type of 3D approach was unable to replicate the ease-of-use to its 2D brethren.

Unfortunately, little new work has been done on improving the useability of these 3D models. The focus in 3D remains photorealism and speed. Newer work in 3D continues to examine the same structural arrangements without attempting to find solutions which address the underlying problems of occlusion, navigability and field-of-view.

People tend to collect lots of images. The larger a user's image collection grows, the harder it becomes for the user to locate specific images. How this large collection is structured and displayed plays an important role towards helping or hindering the user in finding the desired images.

Much effort in this field has been aimed at structuring the image collection in some way to make it easier to navigate. This can include hierarchical structures, such as directory trees, metadata associated with the images, such as keywords, or sorting the images according to some criteria, such as the time the image was created, or the characteristics of the image data itself Such approaches are valid, but do not fully address the problem. An equally important area of the problem is how to display the image collection on screen.

When addressing the problem of displaying a large numbers of images, there are two mutually exclusive requirements. The first is that the image must be displayed on screen so that they are large enough to recognise. However, the second is that much, if not all of the image collection should be displayed, in some structured form, so that the user can see the overall collection and find the desired images quickly.

If the images are too small, the user cannot recognise them. If there are not enough images on screen, the user may become lost in the overall collection, and does not know where to go to locate the desired images. Unfortunately, modern display devices are too small (by many orders of magnitude) to display a large photo collection with large images in its entirety. Even if such a display devices did exist, few users would be able to provide adequate accommodation.

With the rapid consumer take-up of digital video cameras, a way of quickly and easily finding a particular video from a large amount of video collection is also desirable. Many video applications exist to perform a variety of video related works. However, most such applications focus on editing a known video clip or finding video clip from a store of unknown video clips. The applications mostly deal with one video clip at a time, even where more than one video clip appears on the display screen. This requires some amount of time to locate a video clip, which is desirable to reduce.

### SUMMARY OF THE INVENTION

It is an object of the present invention to substantially overcome or at least ameliorate one or more deficiencies of prior arrangements.

The present inventors propose a hierarchy of containers, representing directories, and contained elements in a series of arcs where the width of the arc reflects the number of contained elements in that branch of the hierarchy and the radius of the arc reflects the distance along inheritance lines from the top of the hierarchy.

In accordance with one aspect of the present invention, there is disclosed a method of displaying a collection of data objects, said method comprising the steps of:

determining a visual arrangement of containers which reflects a relationship of said data objects within said collection;

forming a concentric curved shape representing each said container, said curved shape having a geometry and location according to the determined visual arrangement;

establishing a viewpoint for the curved shape which is substantially radial thereto and allows viewing from a primary container of the collection towards one or more subsidiary containers of the collection; and

rendering said curved shape, relative to said viewpoint, to a display.

Advantageous implementations include the representation of hierarchical file structures and file folders.

Numerous other aspects of the invention are also disclosed.

### BRIEF DESCRIPTION OF THE DRAWINGS

At least one embodiment of the present invention will now be described with reference to the drawings, in which:

FIG. 1 is a screenshot of a hierarchical representation according to the present disclosure;

FIG. 2 is a flowchart for a process for reading a directory hierarchy and calculating the sizes and locations for each arc to be displayed;

FIG. 3 is the directory hierarchy shown in FIG. 1 as a prior art expanded directory tree;

FIG. 4 is a table of all the weights and values calculated by the process in FIG. 2 for the directories and photos shown in FIG. 1;

FIG. 5 shows a generic arc of the hierarchy with all important dimensions, offsets and radii labelled;

FIG. 6 is a graphical depiction of the rotation and translation of a scene in response to mouse movement;

FIG. 7 shows the same hierarchy as FIG. 1 but with the mouse substantially towards the left edge of the screen;

FIG. 8 shows the same hierarchy as FIG. 1 but with the mouse substantially towards the right edge of the screen;

FIG. 9 shows the hierarchy of FIG. 1 shortly after a mouse-click on the directory labelled “Sample Photos”;

FIG. 10 shows a view of the “Sample Photos” directory, being the completion of the animation of which FIG. 9 is a frame;

FIG. 11 shows a view of an alternate directory hierarchy according to the present disclosure;

FIG. 12 shows the same hierarchy as FIG. 1 but with the arrangement flattened onto an internal cylindrical projection;

FIG. 13 shows the same hierarchy as FIG. 1 but with the arrangement flattened onto an external cylindrical projection;

FIG. 14 shows the same hierarchy as FIG. 1 but here it is shown as an inwards extending hierarchy rather than a hierarchy that extends from the centre outwards.

FIGS. 15A and 15B show rectangular regions that have images placed into them;

FIGS. 16A and 16B show rectangular regions of images on 3D terrains, where various terrain locations have images associated with them;

FIGS. 17A and 17B show rectangular regions of images each having a current scroll position;

FIG. 18 shows a video browsing window with multiple video clips appearing inside;

FIGS. 19A and 19B shows a set of video clips selected by mouse operations;

FIG. 20 shows a part of a video clip in which the user has interest; and

FIG. 21 is a schematic block diagram of a general purpose computer upon which arrangements described can be practiced.

### DETAILED DESCRIPTION INCLUDING BEST MODE

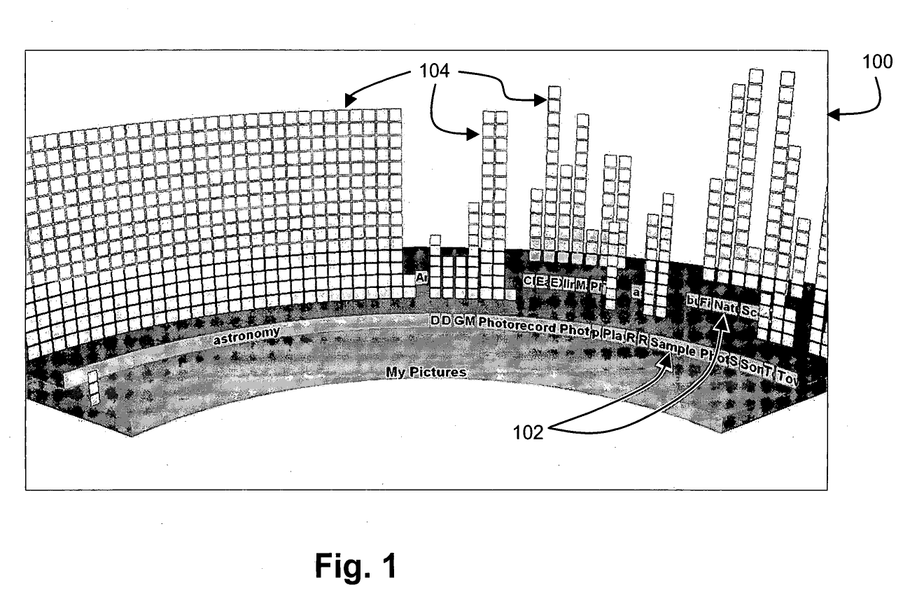

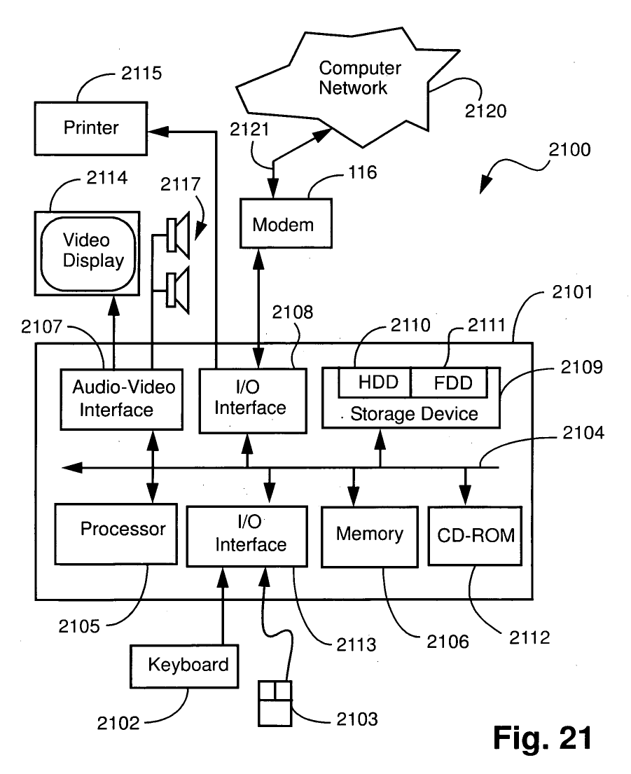

The methods of displaying hierarchical structures to be described herein are preferably practiced using a general-purpose computer system 2100, such as that shown in FIG. 21 wherein the arrangements and processes of FIGS. 1 to 20 may be implemented as software, such as an application program executing within the computer system 2100. In particular, the steps of hierarchical display are effected by instructions in the software that are carried out by the computer. The instructions may be formed as one or more code modules, each for performing one or more particular tasks. The software may also be divided into two separate parts, in which a first part performs the hierarchical display methods and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for display of hierarchical data structures.

The computer system 2100 is formed by a computer module 2101, input devices such as a keyboard 2102 and mouse 2103, output devices including a printer 2115, a display device 2114 and loudspeakers 2117. A Modulator-Demodulator (Modem) transceiver device 2116 is used by the computer module 2101 for communicating to and from a communications network 2120, for example connectable via a telephone line 2121 or other functional medium. The modem 2116 can be used to obtain access to the Internet, and other network systems, such as a Local Area Network (LAN) or a Wide Area Network (WAN), and may be incorporated into the computer module 2101 in some implementations.

The computer module 2101 typically includes at least one processor unit 2105, and a memory unit 2106, for example formed from semiconductor random access memory (RAM) and read only memory (ROM). The module 2101 also includes an number of input/output (I/O) interfaces including an audio-video interface 2107 that couples to the video display 2114 and loudspeakers 2117, an I/O interface 2113 for the keyboard 2102 and mouse 2103 and optionally a joystick (not illustrated), and an interface 2108 for the modem 2116 and printer 2115. In some implementations, the modem 21116 may be incorporated within the computer module 2101, for example within the interface 2108. A storage device 2109 is provided and typically includes a hard disk drive 2110 and a floppy disk drive 2111. A magnetic tape drive (not illustrated) may also be used. A CD-ROM drive 2112 is typically provided as a non-volatile source of data. The components 2105 to 2113 of the computer module 2101, typically communicate via an interconnected bus 2104 and in a manner which results in a conventional mode of operation of the computer system 2100 known to those in the relevant art. Examples of computers on which the described arrangements can be practised include IBM-PC's and compatibles, Sun Sparcstations or alike computer systems evolved therefrom.

Typically, the application program is resident on the hard disk drive 2110 and read and controlled in its execution by the processor 2105. Intermediate storage of the program and any data fetched from the network 2120 may be accomplished using the semiconductor memory 2106, possibly in concert with the hard disk drive 2110. In some instances, the application program may be supplied to the user encoded on a CD-ROM or floppy disk and read via the corresponding drive 2112 or 2111, or alternatively may be read by the user from the network 2120 via the modem device 2116. Still further, the software can also be loaded into the computer system 2100 from other computer readable media. The term “computer readable medium” as used herein refers to any storage or transmission medium that participates in providing instructions and/or data to the computer system 2100 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 2101. Examples of transmission media include radio or infra-red transmission channels as well as a network connection to another computer or networked device, and the Internet or Intranets including e-mail transmissions and information recorded on Websites and the like.

The methods of hierarchical display may be implemented using dedicated hardware, such as one or more integrated circuits performing one or more of the functions to be described. Such dedicated hardware may include graphic processors, digital signal processors, or one or more microprocessors and associated memories.

Desirably the hard disk drive 2110 has a directory-based file system which contains digital photos (among other files), and the computer module 2101 has an is operating system incorporating a window-based display capability including menus and 3D rendering support operable under control of the mouse 210 and keyboard 2102. Preferably, the 3D rendering is supported by hardware acceleration for example using a dedicated graphic processor.

Since the computer application program is substantially a tool for human-computer interaction, it is expected that there will be a “user” during the operation of the program. The user is any individual operating the computer program and interacting with it via the mouse 2103 or keyboard 2102. The mouse 2103 is moveable across a surface, of a desk for example, to re-position a cursor or pointer on the display 2114. The mouse 2103 includes buttons, schematically illustrated in FIG. 21, to permit selection of an icon or other graphical user interface (GUI) element, to cause some function or operation to be performed. It is also expected that the user is the owner or manager of the files particularly the digital photos, located on the hard-drive 2110 or hard-drives attached to the computer 2101, for example resident within the computer network 2120. In this specification, reference to moving the mouse 2103, is to be interpreted, unless otherwise expressly state, as a corresponding movement of the cursor or pointer represented on the display 2114 as part of the GUI.

The described arrangements provide solutions for the user to the problem of locating digital photos which they may have on their hard drive. The digital photos on the user's computer 2101 will be referred to herein as the user's “photo hierarchy”.

It is typical that all, or substantially all, of the user's photos will be in a single directory and subdirectories of that single directory. This distribution of photos across the single directory and its subdirectories forms the hierarchy. It is further typical that the user will have created this hierarchy of directories under this starting point directory to sort and categorise the digital photos in a manner that is desirable to the user.

The rationale behind this sorting is to keep the collection manageable, because locating 1 file in a sorted directory of 20 is much easier than locating 1 file in a completely unsorted directory of 10,000. However such slows the traditional file-system based access to the photos within the collection because instead of being located immediately at the starting point directory, the user must descend a number of directories (using previous knowledge about the photo's location) to relocate any photo in the hierarchy.

A solution to this dual desire of maintaining a structured hierarchy and allowing fast access to elements within the hierarchy is a significant aspect of the greater problem of digital photo access.

To begin, the user launches the computer application program using any method inherent to the operating system of the computer 2101. The preferred implementation is dependent on a starting point from which to being reading the user's hard drive 2110. It is expected that the user will want this “starting point directory” to be their aforementioned “single directory” which is the top, or root, directory of their photo hierarchy. Under the Microsoft Windows™ operating system, there is a “My Pictures” directory into which users are strongly encouraged to store their digital photo hierarchy. Under Apple Mac™ OS X operating system there is similarly a “Photos” directory. On initial and subsequent execution until the changed by the user, this operating system default would be the implied starting point directory. If the user employs a different directory as the root of their photo hierarchy, the user can specify that root at any time during the application program's execution by selecting a menu item which presents an operating system default directory selection dialog box, allowing a different starting point to be chosen.

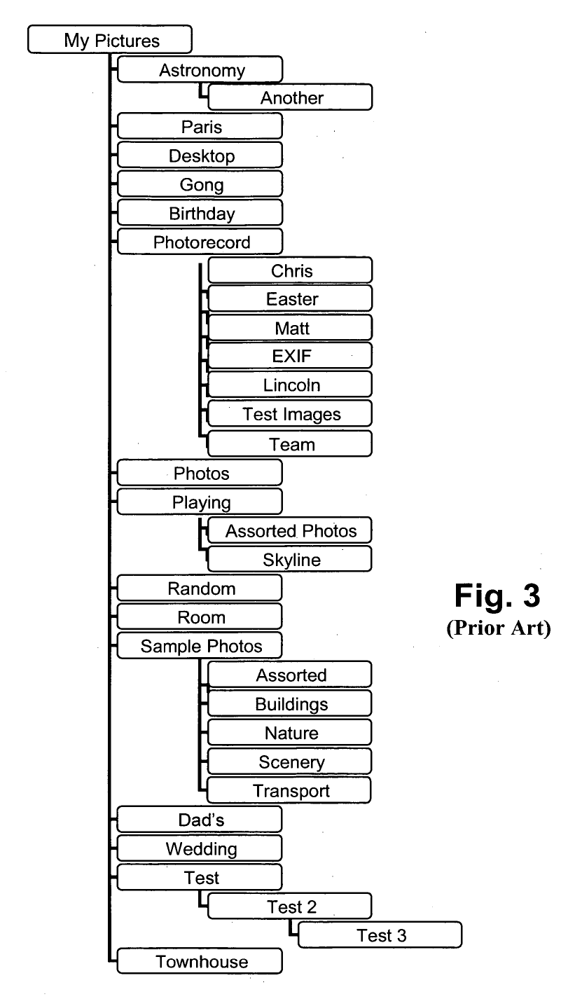

FIG. 1 is a screenshot of a hierarchical display according to the present disclosure operating under the Windows™ operating system. The screenshot 100 shows a hierarchy of 43 directories 102 containing 710 photos 104. The hierarchy is displayed curved around an arc of 0.8π radians. The directories 102 are formed as concentric containers arranged in a fashion akin to a curved staircase, with each set of stairs forming a corresponding level of the hierarchy. Arranged on each “stair” are those photographs or sub-directories that hierarchically depend from the present directory or container. The example of FIG. 1 affords an alternate hierarchical representation to that shown in the prior art of FIG. 3. The effect to the user of launching the computer application program is that this view from FIG. 1 is displayed as a GUI in the main view area of the program's window upon the display 2114. This example resultant output will be used to discuss how the output's geometry is calculated and how the scene is constructed and drawn (rendered).

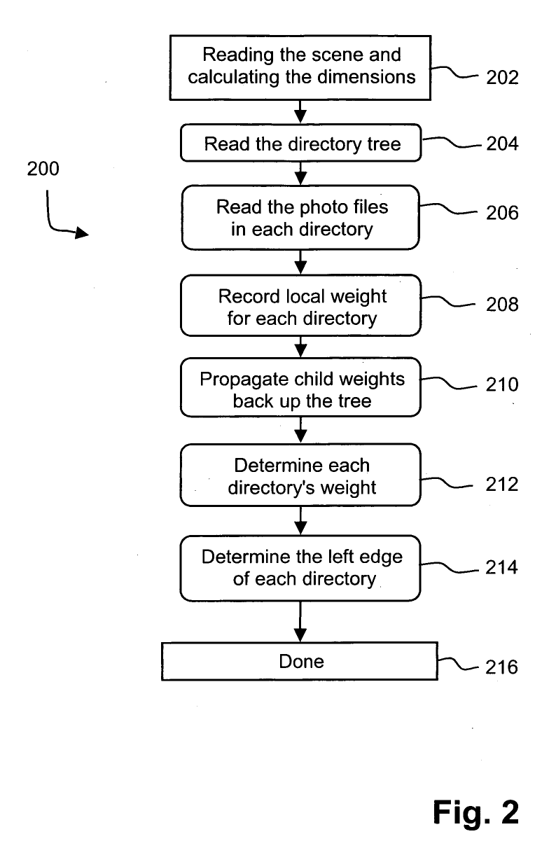

After the application program is launched and every time the user specifies a new starting point directory, the program loads the entire photo hierarchy according to the process 200 in FIG. 2. The process 200 may be referred to as “Reading the scene” 202 because the information read and calculated here will be used to construct the scene presented to the user in the main display window generated by the application program.

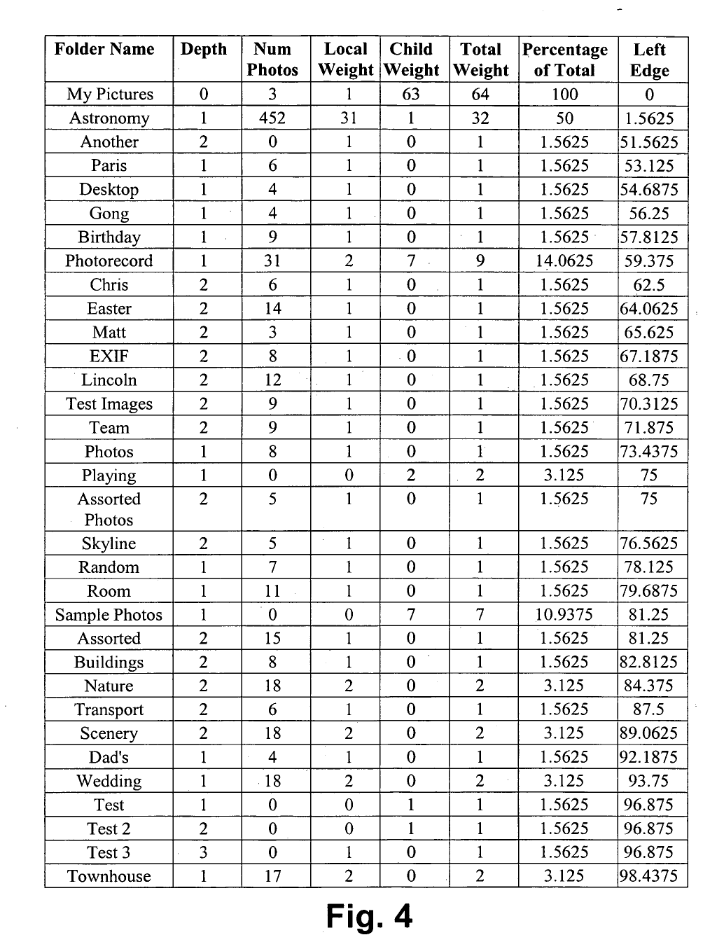

The first substantive step 204 in the process 200 is to “Read the directory tree”. This involves using the operating system to read from the file system every directory contained in the starting point directory and for each directory read, reading every directory contained therein, and so on until there are no further directories. This traversal is typically performed either depth or breadth first. A structure in the program's memory is allocated for each directory and a reference to the directory is stored as part of this structure as is a “depth” value which is the depth distance in the hierarchy between the root director and each respective directory. The result of step 204 is a table, such as that shown in FIG. 4, quantifying the structure of the hierarchy. The table of FIG. 4 may be retained in the memory 2106, being local memory for operation of the application program being executed by the processor 2105.

For the example hierarchy shown in FIG. 3, step 204 involves reading each directory from the file system in the vertical order that they appear in FIG. 3. The structure in memory for each directory would then have the directory reference, “Folder Name” and “Depth” values from FIG. 4 stored in it. The directory reference is a file system specific value and may be a file path, inode value or other reference type which allows the directory to be uniquely retrieved at a later time from the file system.

Once the traversal is complete, the reference is used to return to each directory in turn, as part of step 206 of FIG. 2, where every photo file in each directory is read. For each photo file read, a structure in the program's memory is allocated and linked from the structure for the directory in which the photo was discovered. The number of photos in each directory in the example is recorded and listed in the “Num Photos” column of FIG. 4.

The next step 208 of the process 200 is to record the “local weight” for each directory. This local weight is simply the number of contained photos divided by a scale factor. In this example, a scale factor of 15 is used, this being the “tower height” of the hierarchical display, rounded up to the nearest whole integer. The scale factor of 15 is a preset value, chosen to fulfil an appropriately aesthetic width to height ratio for the scene. The scale factor may be varied for alternate representations. For directories with sub-directories and no photos, a local weight of 1 is used. This value is stored in the respective directory's structure. The local weight for each directory in the example is listed in the “Local Weight” column of FIG. 4.

The fourth step 210 in the process 200, “Propagate child weights back up the tree” involves a depth-first, recursive traversal of the directory entries in the program's memory 2106. During this recursive traversal, all directories that contain no sub-directories simply return their local weight. Directories that do contain sub-directories return their own local weight, plus the sum of all values returned by their immediate sub-directories. For each directory, the sum of the values returned by all immediate sub-directories is called the “Child Weight” and the sum of the “Child Weight” and the “Local Weight” is the “Total Weight”. The child and total weights for each directory in the example are then recorded and seen listed in the “Child Weight” and “Total Weight” columns respectively of FIG. 4.

Step 212 takes the total weight of the starting point directory and uses it to determine the relative weight (as a percentage) of each sub-directory in the hierarchy. This is simply the “total weight” for each directory, divided by the “total weight” for the starting point directory, multiplied by 100. The relative weight for each directory in the example is listed in the “Percentage of Total” column of FIG. 4.

The final step of the process 200 is step 214 to “Determine the left edge of each directory”. Step 214 is performed by a depth-first, recursive traversal of the directory tree. During the traversal, the total of all local weights so far traversed (not including the current directory) is expressed as a percentage of the total weight of the starting point directory and this percentage is ascribed to the current directory's left edge value. The left edge for each directory in the example of FIG. 1 is listed in the “Left Edge” column of FIG. 4. The process 200 then ends at step 216.

Once these calculations are made, the scene can be rendered. Rendering of the hierarchical scene can be achieved using a standard 3D rendering language, such as OpenGL, to a window or similar display target, such as an HGLRC in Microsoft Windows™. Rendering is performed by the processor 2105, possibly in concert with any specific 3D hardware accelerator, to output a displayable image to the display device 2114.

The rendering of the scene itself is described relative to a chosen “base geometry”. In the present implementation, the base geometry is a 0.8π radians circular arc (equivalent to 144°), oriented such that the endpoints are significantly close to, while still being marginally inset from, the two bottom (near) comers of the viewable 3D buffer, whilst remaining centred horizontally. The arc is predominantly concave towards the viewer but angled slightly upwards affording a perspective by which background components of the scene can be viewed with minimal but naturally interpretable occlusion by foreground components. The absolute dimensions of the arc are unimportant, provided that the radius (R_{B}) of the arc is sufficient to satisfy the constraints of the endpoint locations. The 0.8π radians of the arc will be called A_{T}—the total arc curvature.

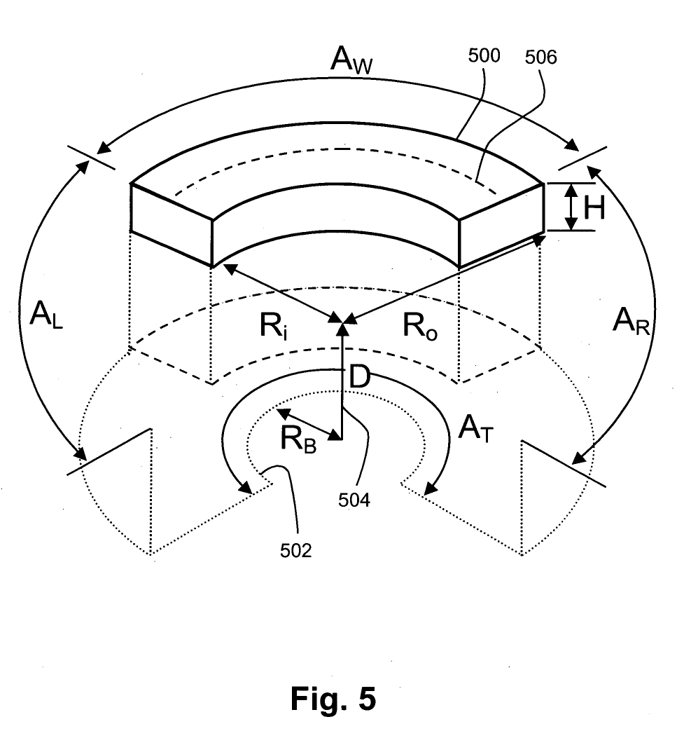

Given this base geometry, a 3D shape representing each directory in the hierarchy is then drawn. Generally speaking, the 3D shape is a segment or section of a 3D annulus. The geometry of each drawn shape is described according to the dimensions in FIG. 5. In FIG. 5, the shape 500 drawn is indicated by the solid thick black lines. The “base geometry” is also shown at 502 as the dotted arc of which R_{B} is the inner radius.

The 3D shape 500 in FIG. 5 is described by its inner and outer radii (Rᵢ and Rₒ respectively), its angular width (A_{W}), its height (H) and its angular distance from the left and right endpoints of the base geometry arc described previously (A_{L} and A_{R} respectively). The centre point of the two radii (Rᵢ and Rₒ) is always located on a vector 504 drawn perpendicular to the plane of the base geometry arc 502 but which passes through the base geometry arc's centre point The displacement in a substantially 20 vertical direction of the radii's centre point and the base geometry's centre point is ascribed the value D, this being the magnitude of the vector 504. A dashed line 506 drawn in FIG. 5 along the top of the 3D shape is the “centre line arc”.

In this example, the height (H) is one twentieth of the base geometry's radius (R_{B}). This ratio is selected for aesthetic reasons. This is the only constant dimension of the shape 500, and all other values are variable depending on which directory the shape is being used to represent.

The previously mentioned “total arc curvature” (A_{T}) is always equal to A_{L} Plus A_{W} plus A_{R}. In this respect, FIG. 5 is drawn to different specifications than the preferred implementation as A_{T} in FIG. 5 is closer to 1.57π radians than 0.8π radians, and H is shown as greater than one twentieth of R_{B}. This aids in illustrating the relationship between the variables.

The process of drawing (ie. rendering) the 3D shape 500 for each directory requires determining values for Rᵢ, A_{L}, A_{W} and D as follows:
Rᵢ=R_{B}+(R_{B}/3)*(directory depth)
Rₒ=Rᵢ+(R_{B}/3)+(R_{B}/3)*(max child depth−directory depth)
A_{L}=A_{T}*(left edge percentage/100)
A_{W}=A_{T}*(percentage of total/100)
D=(R_{B}/20)*(directory depth).
   Given these values and the implied relationships to all other values which define the directory's shape, the top, front and two ends of the shape can be drawn with OpenGL primitives, where such is being used for rendering. Back and bottom faces need not be drawn.

The result is that the directory at the top of the hierarchy will have a shape drawn with Rᵢ equal to R_{B}, A_{L} and A_{R} equal to zero, and A_{W} equal to A_{T}. The displacement D is zero. This means that the bottom inner edge of the shape for this root directory entirely follows the base geometry arc 502. All subsequent directories will be drawn higher, further out and yet nested within the arc of this directory. As clearly seen in FIG. 1 and others, directories at the same level in the hierarchy are formed by annulus sections adjacently aligned according to the corresponding annulus of which they form a part.

Once the directories are drawn, it simply remains to load the thumbnails for each photo contained in each directory, arrange the thumbnails into groups of 15 (being the “tower height” discussed above), scale each thumbnail such that it is as wide and tall as the centre line arc distance along the top of the directory's shape (minus the centre line arc distance along the top of its child directories) divided by the number of tower groups formed by thumbnails for that directory, and draw (ie. render) the thumbnails as textured quadrilaterals in linear vertical towers of 15, evenly spaced along the centre line arc of the directory's shape (again, minus the centre line arc distance already occupied by its child directories).

The described implementation also has a text texture drawn centred on the front of the each shape, labelling the shape with the name of the directory it represents.

The result of the “Reading the scene” and the drawing processes for the example photo hierarchy is shown in FIG. 1. For visual simplicity in FIG. 1, the thumbnails are drawn as flat-shaded squares rather than actual textured quadrilaterals.

Once the scene is fully displayed as a GUI upon the display 2114, the user can interact with the scene using the mouse 2103. There are two types of interaction possible using the mouse 2103, those being “mouse movement” and “mouse clicking”.

In response to mouse movement, the described implementation rotates the scene with respect to the viewer about the vertical axis (formed by the vector 504). The amount of this rotation is such that moving the mouse from the left edge of the display screen 2114 to the right edge of the screen 2114 rotates the scene by:
(the total arc curvature angle A_{T})−(the field-of-view angle of the 3D scene).
At the same time, the scene is translated horizontally by the horizontal distance the mouse 2103 moves, projected to the depth of the centre point of the arc.

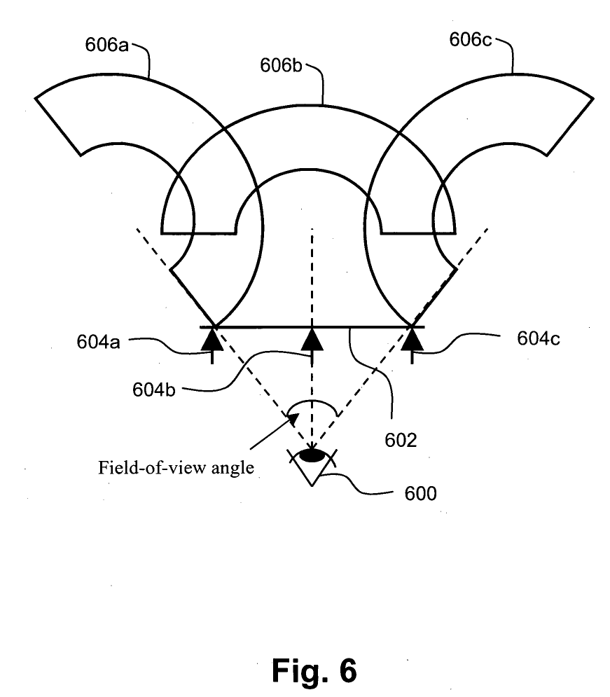

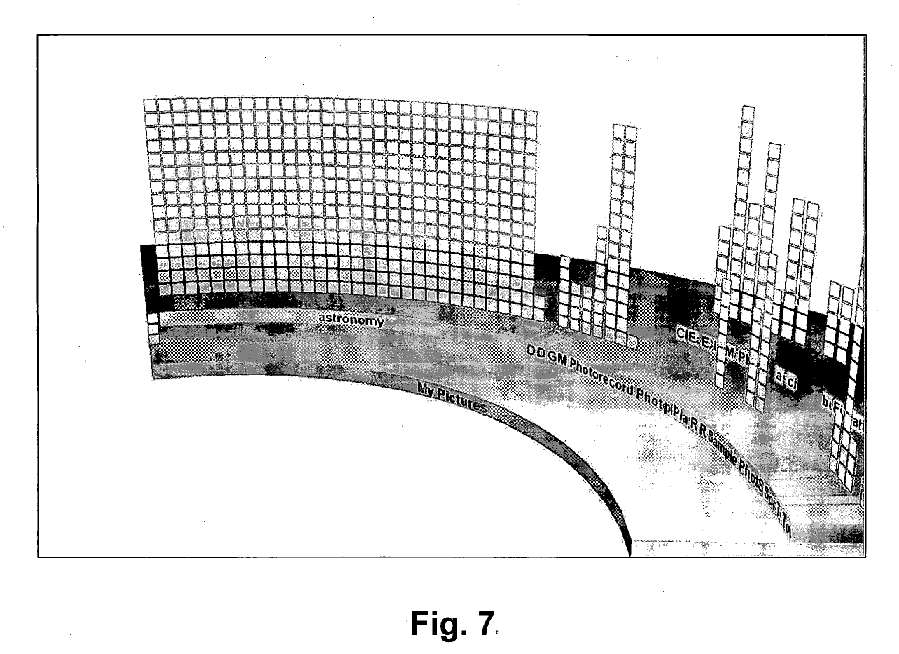

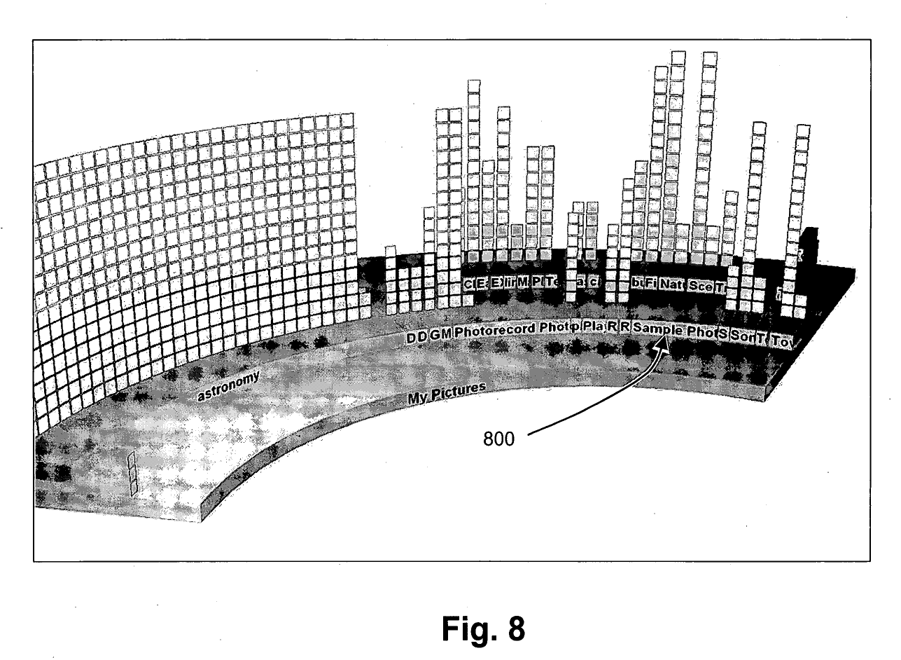

This rotation and translation of the scene in response to mouse movement is depicted in FIG. 6. FIG. 6 shows an eye 600, representing the user's 3D viewpoint and depicts a vertical slice of render window (the area where the scene is drawn) by a horizontal line 602. Three arrows 604a-604c pointing at the line 602 depict three horizontal locations of the mouse 2103 as it moves across the render window. The three semi-circular shapes 606a-606c are the three orientations of the scene when the mouse 2103 rests at these three locations 604a-604c. The location 604b affords the front-on view, effectively seen in FIG. 1, the location 604a affords the view of FIG. 7, and the location 604c affords the view of FIG. 8. The dashed lines drawn from the viewpoint 600 represents the straight line upon which the viewpoint 600, mouse 2103 and the centre point of the scene always rest. Since the viewpoint 600 is always fixed and the mouse 2103 is user controlled, these lines define the location of the centre point of the scene (which is always at the same depth).

The result of this rotation and translation can be seen in: FIG. 7, corresponding to mouse position 604a; FIG. 1, corresponding to mouse position 604b; and FIG. 8, corresponding to mouse position 604c. All three show the same scene and same content but with the mouse 2103 substantially towards the left, centre and right of the render window respectively.

The advantage of this navigation approach is that such allows arcs of any angle, and which may or may not fit within the bounds of the render window, to be navigated as simply as a flat plane that is fully contained within the bounds of the window. This allows a significantly larger virtual area for use.

The translation further ensures that, despite the rotation, an area that the mouse 2103 moves towards will never move away due to rotation. The translation also orients the scene so that the user always sees straight down the radial line that the mouse 2103 is over.

Another result of the combination of these two transformations is that the area of the scene that the mouse 2103 is over is always the area of the scene which is perpendicular to the line of sight, and thus forms the focal point and easiest viewed part of the scene.

The other type of mouse interaction that the user can have with the scene is to click on an area of the GUI. In the present implementation, there are two different areas that can be clicked: photo thumbnails and directory arc shapes. Clicking on a thumbnail results in the thumbnail zooming to the front of the view and filling the whole screen—thus assuming a “full screen” view until dismissed with another mouse-click upon which time it will return to its former location, and the view similarly reverts to the hierarchical scene (eg. FIG. 1).

Clicking on a directory arc results in that directory arc becoming the new “starting point directory.” and the scene is reloaded and redrawn accordingly. To further aid in conveying this transition to the user, the transition may desirably be animated, for example in the fashion used in the aforementioned ZoomBrowser™ computer application.

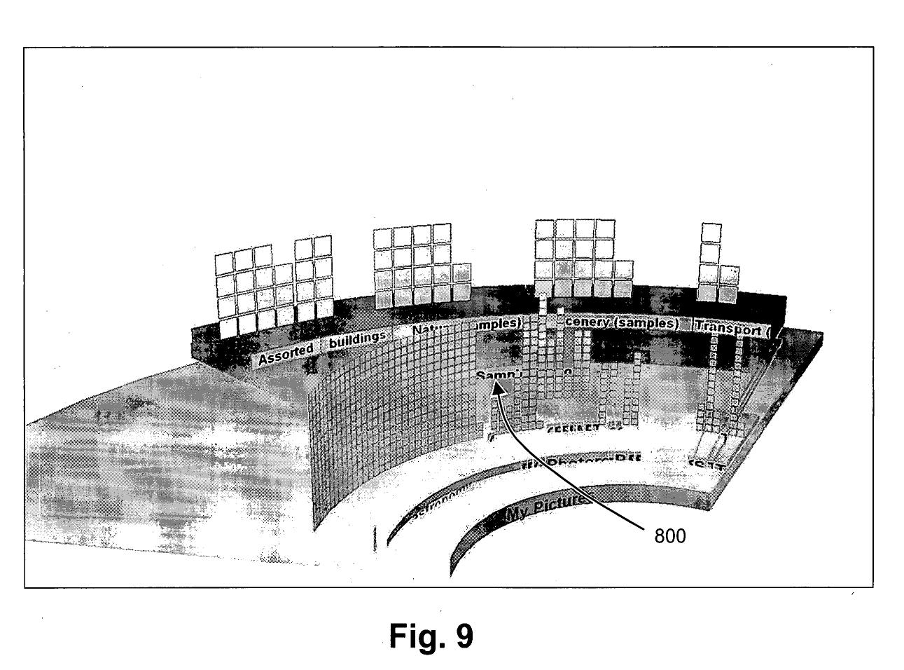

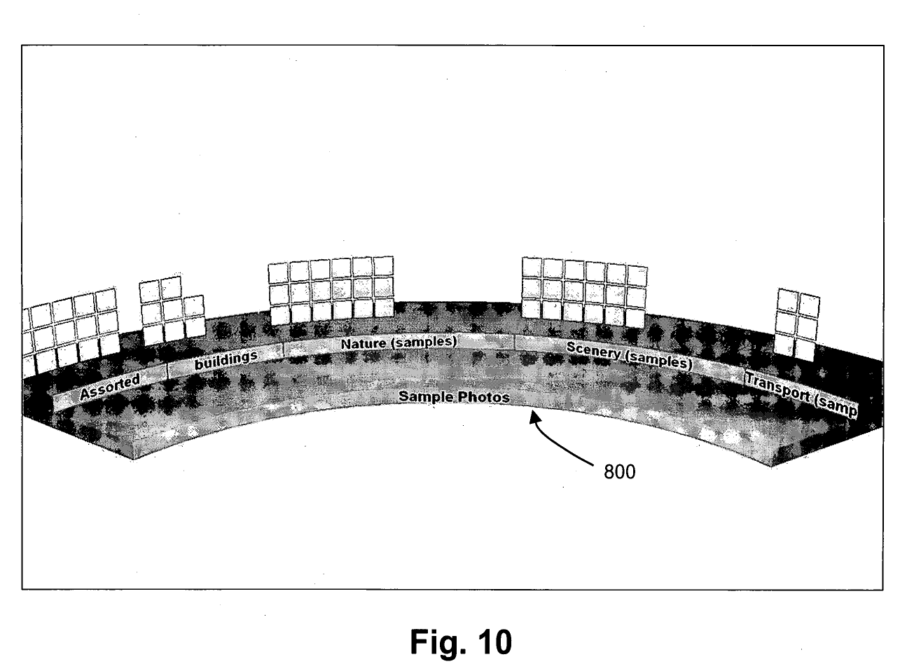

An example of animation is shown in the example of the user clicking on the “Sample Photos” directory arc shape 800 in FIG. 8 (note that only “Sample Pho” of the label is visible in FIG. 8). This action results in all arcs, except the arcs contained by the “Sample Photos” hierarchy, animating smaller, inwards and down while simultaneously becoming transparent. At the same time, the “Sample Photos” hierarchy expands and grows until it fills the entire space that the vacating “My Pictures” hierarchy occupied. FIG. 9 shows a frame of animation in the middle of the transition. In FIG. 9, all other directories have started to shrink, fade and disappear into the centre of the arcs and simultaneously fall down through the level of the floor, while the “Sample Photos” arc has begun to grow and is moving towards occupying the same space that the “My Pictures” directory occupied previously. The final destination of the animation is shown in FIG. 10.

In a preferred implementation, clicking in front of the starting point directory's arc shape results it the directory above it in the file system's directory tree being chosen as the new starting point directory. In alternate implementations, icons, shapes or labels may further indicate levels of the file system directory tree above the starting point directory and the user may click on one of those to select a higher starting point.

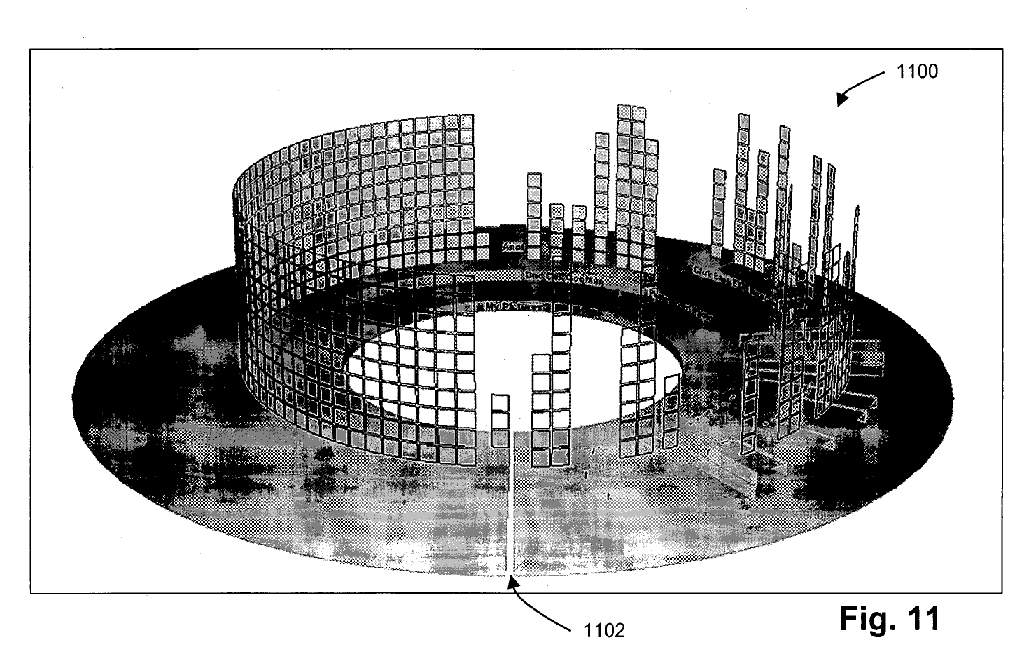

In an alternate implementation, the total arc curvature of the scene is changed. FIG. 11 shows a view 1100 of a substantially different directory hierarchy. This view is shown on an arc of substantially 2π radians as opposed to the 0.8π radians used in all previous examples. FIG. 11 also shows the same photo hierarchy as FIG. 1. The total arc curvature is almost 2π radians so as to provide a small gap 1102 to provide a reference point. Further, the entire scene has been moved further away from the viewpoint so that the view 1100 is more surveying than immersive. Photos whose back or reverse side face the viewer are rendered using back face-culling so that they appear only as wire frames and the user can see straight through them and thus observe other, more distant photos.

Another implementation involves showing video data as well as, or instead of photographic thumbnails in the computer program. Other types of data such as icons, pictures, animations or shapes, may be similarly displayed.

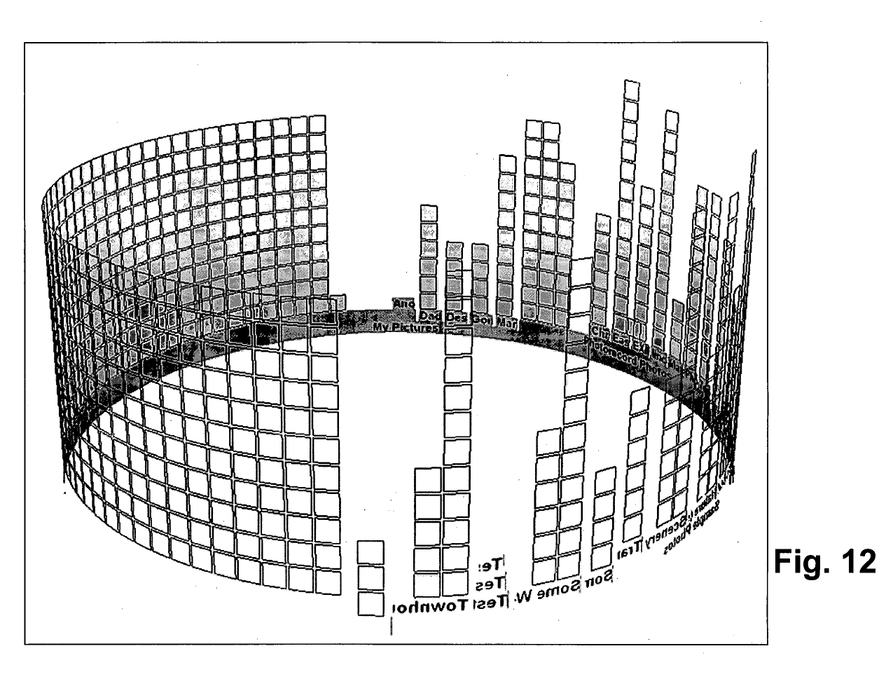

The radial geometry may also be flattened so that the scene becomes a projection onto the inside of a section of a cylinder. FIG. 12 shows an example output of a flattened radial geometry for the same photo hierarchy as displayed in FIG. 1.

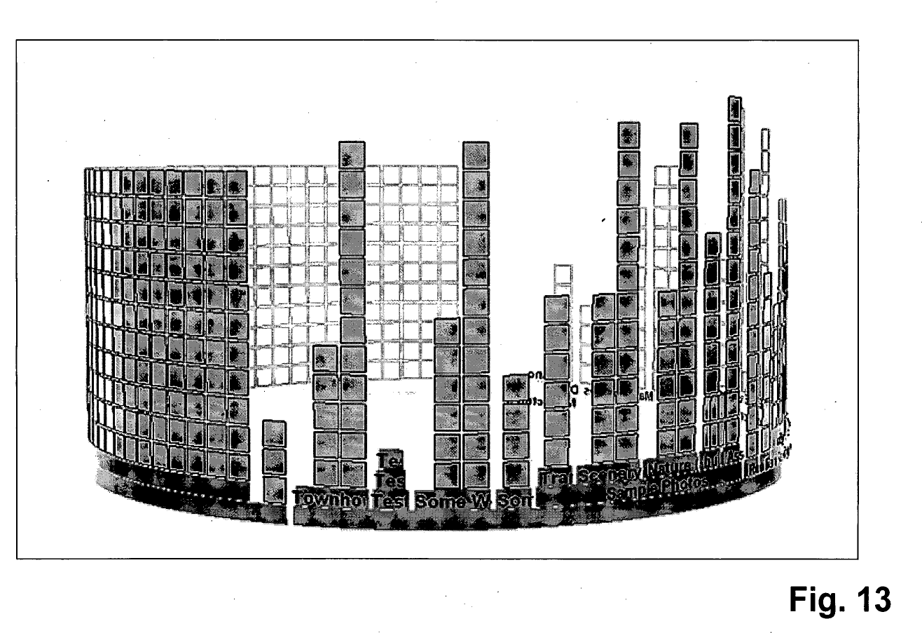

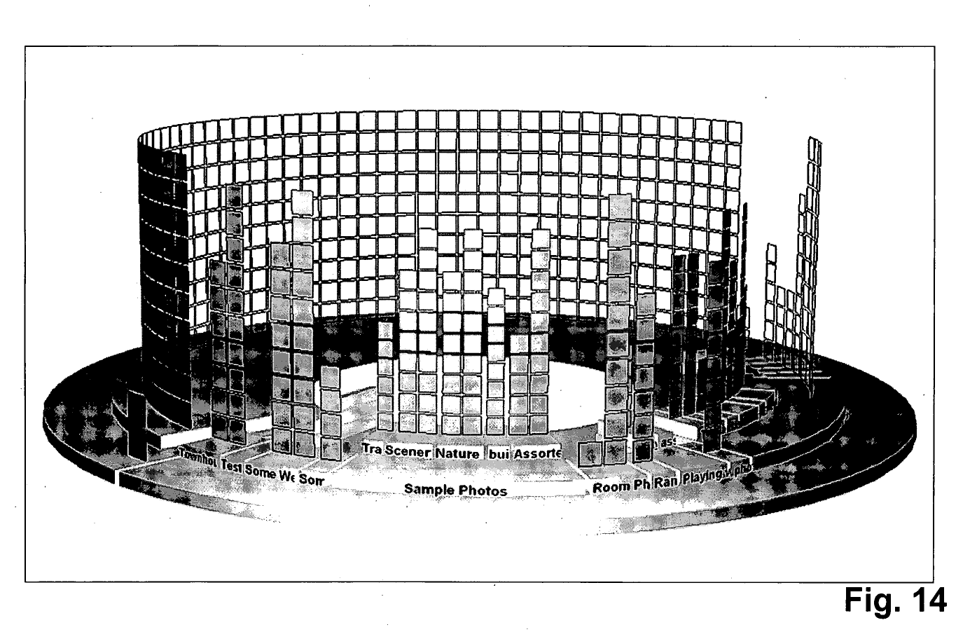

A further alternative instead projects the scene onto the outside of a cylinder. Here, the direction of rotation of the scene in response to movements of the mouse 2103 is reversed. FIG. 13 shows an example output for this implementation for the same photo hierarchy as displayed in FIG. 1. In a further variation, where the user views the arrangement by looking inwards from the outside, the hierarchy is not shown as a flattened projection onto the outside of a cylinder, but rather is a 3D structured arrangement like FIG. 1 with depth extending inwards towards the centre of the circle rather than outwards and with depth decaying towards the centre such that the centre of the circle is an asymptote. An example output of this inwards extending implementation is shown in FIG. 14 displaying the same photo hierarchy as FIG. 1.

Further implementations may be used to project the geometry of the scene onto the inside or outside of a sphere, instead of the ostensibly cylindrical projections presented thus far. In navigating spherical implementations (not illustrated), the horizontal rotating and translating behaviour is complemented by adding simultaneous vertical rotating and translating behaviour, thus allowing access to all latitudes as well as longitudes.

As a visual presentation to the user, each of the described implementations can be subtly or significantly adjusted to alter the visual aesthetic presented. This may include different colouring for each directory arc shapes to visually reinforce the polar coordinate location of the arc shape with respect to the centre of curvature.

In a further implementation, which visually enforces the hierarchical containment concept in a different manner, the sides of each directory arc shape may be arranged to extend upwards to envelope or otherwise contain the photos presented within.

There are numerous advantages with the scene configurations presented herein when compared to the prior art. With respect to photo hierarchy viewers based around collapsible/expandable file trees, there is the immediate advantage that all photos at all levels of the hierarchy are displayed. This provides for every thumbnail in the scene to be accessible within a single mouse-click.

With respect to viewers reliant on two-dimensional grids of thumbnails, the curved surface provides a larger virtual area onto which thumbnails can be placed. Three-dimensional geometry also provides better possibilities for visual structure since depth can be used to convey further meanings. For example, a depth offset is used to further emphasise the directory depth in the photo hierarchy. Also since the photos can be arranged perpendicular to the plane which describes the hierarchical arrangement, less sacrifice of thumbnail space must be made to display hierarchical information. All these features aid human perception of the directory structure.

With respect to any program which pans or scrolls across a 2D surface larger than the window in which the GUI is reproduced, the navigation of the 3D cylinders and sphere presented here accelerates the navigation of the virtual work-area by eliminating the need for a specific mouse click action to scroll. Further, this approach works more robustly than automatic panning in 2D since the curvature of the 3D surface towards the edge of the screen 2114 provides better look ahead as well as focus on the area under the mouse 2103.

In comparison to prior art 3D hierarchical arrangements, the weighting and placement of arc widths in the described arrangements ensures that occlusion (a major limitation of displaying 3D on a 2D screen) along radial lines does not occur. Further, the navigation of the scene means that no modal rotation, view change or alteration of the scene needs to occur to facilitate viewing. Basic mouse movement across the screen 2114 will achieve all required scene manipulation automatically.

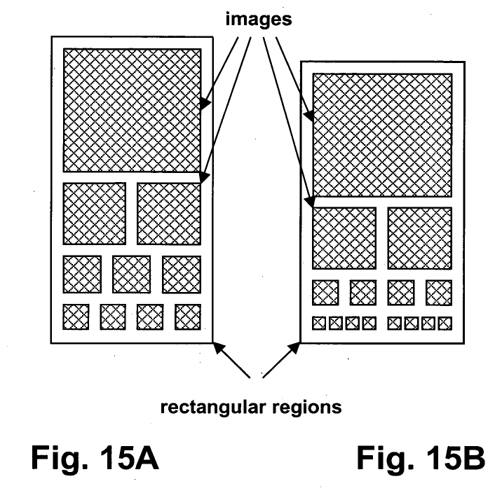

FIGS. 15A and 15B show rectangular regions that have images placed into them according to this disclosure. The regions for example may be the towers 104 of FIG. 1 and related figures. FIG. 15A shows one variation of presentation that based upon an algorithm where row n has n images, affording a simple pyramid structure, based on a proportional nature of rows and numbers of images in each row. FIG. 15B shows another variation based upon an algorithm where row n has 2ⁿ⁻¹ images, affording an exponential pyramid structure. Note that in each of these examples, since the regions are rectangular, as the number of photographic images in each row increases, their relative size correspondingly decreases.

The arrangement of FIG. 15A may be referred to as an “eye-chart” method, which fills the region with images one row at a time. The first row has one image, the second row has two images, the third row has three images, and so on until all the photos are used up. Additionally, the rectangular region can be clipped to best fit the images. Thus the nth row has n images. As a modification, the top row can have any arbitrary or predetermined number of images, with each row further down having one more image than the previous row.

In a similar modification to FIG. 15B, the top row can have any number of images, with each row further down having double the number of images as the previous row.

Many further variations are possible, including some where certain neighbouring rows have the same number of images, but the number of images per row generally increases as the row number increases.

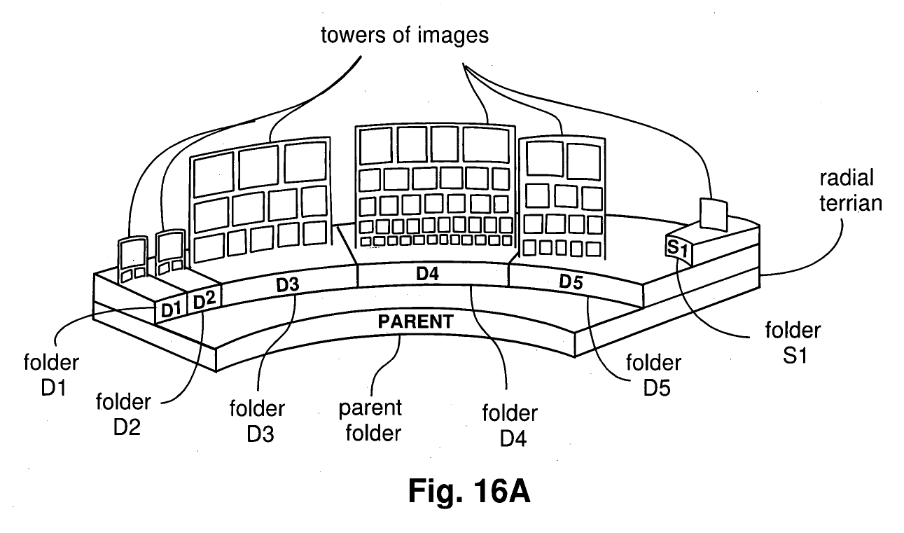

FIGS. 16A and 16B show rectangular regions of images on 3D terrains, where various terrain locations have images associated with them. FIG. 16A shows a radial terrain, representing a file structure hierarchy, consisting of a parent folder, containing five folders, D1, D2, D3, D4, and D5. Folder D5 contains a folder S1. Towers of images represent the images in each folder.

FIG. 16B shows a grid terrain, with each cell representing one month of a year, as designated by month labels and year labels, with towers of images representing all the photos taken in that month.

One particularly useful application of the arrangements of FIGS. 15A and 15B, is when a 3D terrain is being used. Various parts of the terrain have images associated with them, and those images are displayed as towers of images rising out of the terrain. In such a situation, it is likely that a tower of images will be partially obscured by another tower positioned in front of it. In such a situation, using the arrangements of FIG. 15A or 15B, the larger images at the top of the tower are more likely to be seen, while the smaller images at the bottom of the tower are more likely to be obscured.

In a radial terrain, which may be used to represent a typical file system hierarchy, towers of images can be used to depict the images in a particular folder.

In a grid terrain, which may be used to represent a calendar, towers of images can be used to depict the images that were taken in a particular month or day.

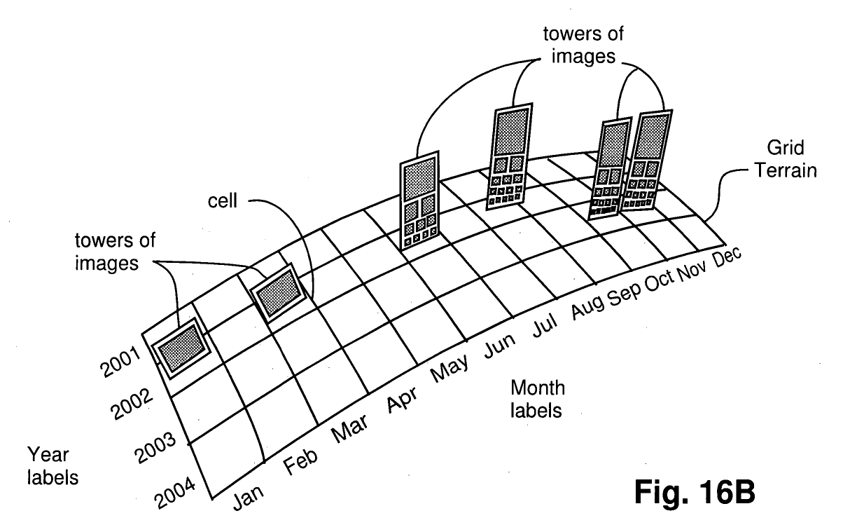

FIGS. 17A and 17B illustrate how the layout of thumbnail images in a rectangular region may be modified by scrolling or mouse movement. FIG. 17A shows a rectangular region of images that has a current scroll position approximately two-thirds of the distance towards the top of the rectangle. In this position, thumbnail images H and I are displayed at a larger relative size than those other thumbnails in the region. Observe that the size of other thumbnails diminishes according to the lateral distance from the images H and I. In FIG. 17B, a similar view is shown but with the mouse moved, or scrolled, within the region scrolled down by one, thus now being centred over images J and K.

FIGS. 17A and 17B therefore illustrate a method for filling a region with images. Preferably the region is rectangular. The images may be still images, video streams playing in-place, or any other form of static or moving 2D pixel data.

In FIGS. 17A and 17B, a scroll position is associated with the region. This scroll position can be represented and manipulated by a scroll thumbwheel upon the mouse 2103 where fitted, or by movement of a cursor associated with the mouse 2103. A current scroll or cursor position determines the row of images that is the largest. Rows of images above and below the scroll position grow smaller the further they are from the current scroll position. Since the number of images in a row must change when their scale changes, images will shuffle around when the scroll position changes. This is seen in FIGS. 17A and 17B where, for example images J and K move from a row of three images in FIG. 17A to a row of two images in FIG. 17B. The shuffling may be animated, affording an exiting appearance to the user.

In any region with rows, one row will contain the largest image(s). That row will also contain the least number of images. Scrolling the region by the smallest amount possible will scroll the region by this number of images.

It should be noted that the region does not have to be filled with rows of images. Other packing arrangements may be used.

A further variation of image representation involves playing multiple video clips in a video browsing window. This may be achieved, according to the present disclosure, in two different modes, being a fully automatic mode and a mouse selecting mode.

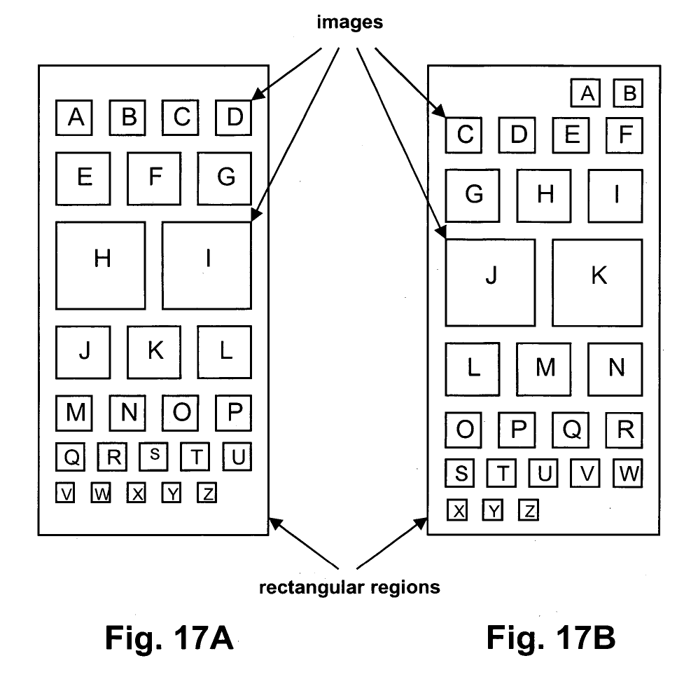

When the fully automatic mode is established, when a set of video clip 10 representations (ie. icons or thumbnails within the browser window) have been selected, for example by selecting a directory or selecting a category or some other means, the video clips associated with the corresponding representations appearing within the video browsing window start to play simultaneously. As shown in FIG. 18, video clips associated with representations V1, V2, . . . , V16 within a GUI window 1800 will start to play at same time automatically. [Typically, the video clips may be decoded using Windows™ APIs, such as “Windows Media” and “DirectShow. These are technologies that drive Windows™ Media Player, a common reproduction tool in Windows™ operating systems. In this implementation, since 16 clips are being shown, DirectShow would decode frames from 16 different media files, this being within the capability of modem computing hardware, and the resulting outputs (bitmaps for each frame) are then used to fill the rectangular thumbnail representing each video clip. Preferably, each clip plays the most interesting part thus providing a useful preview to the user.

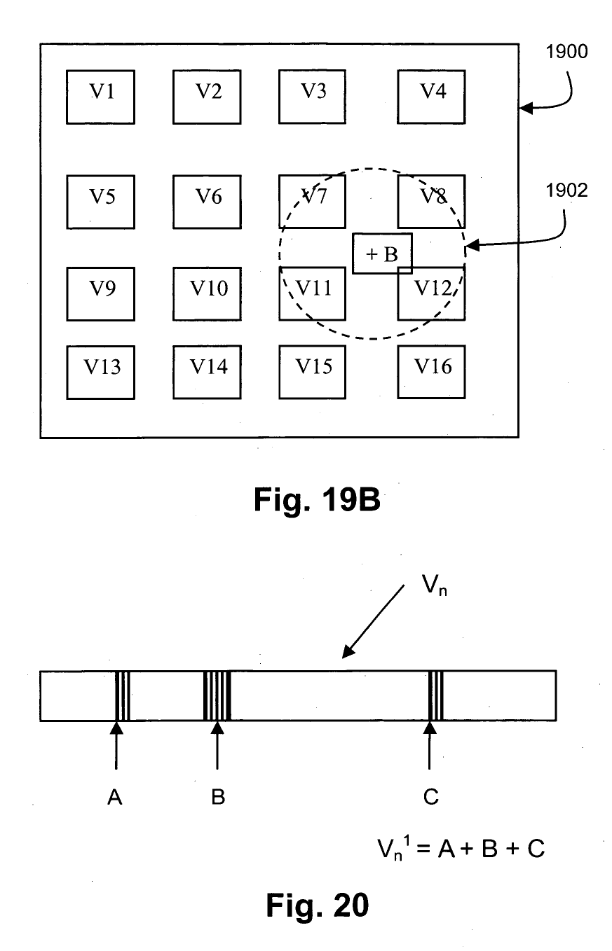

As shown in FIG. 20, the most interesting part Vn′ of a video clip Vn can be represented as a separate video, associated with the main clip Vn, by a hyperlink for example. In the implementation of FIG. 20, Vn′ is preferably a combination of an interesting part A, an interesting part B and an interesting part C. Alternatively, the most interesting part can be described by associated metadata, which indicates the interested parts A, B and C within the original video clip V. The interesting part of each video clip is desirably played in the same location of the browser window 1800 as the video clip itself For example, V1′ plays at the same position of V1, and V2′ plays at same position of V2, and so on.

In the mouse selecting mode, a set of video clips is selected by selecting a directory or selecting a category or some other means, and those video clip representations appearing within the video window are configured to start to play the corresponding interesting part depending on the mouse position within the window. If the mouse 2103 is outside the video browsing window, no video clip will start to play.

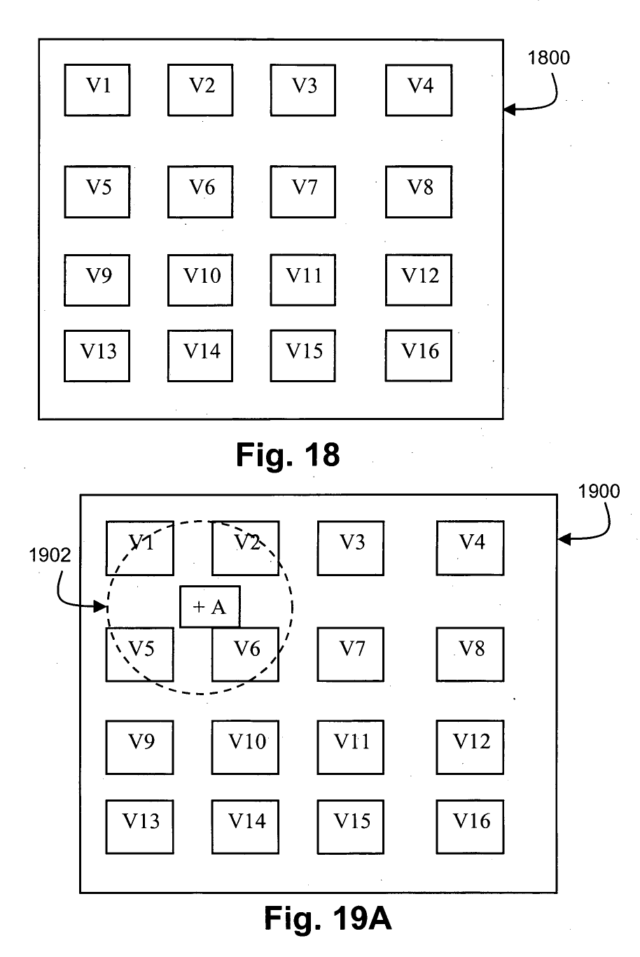

For example, as shown in FIG. 19A, if the mouse 2103 is moved inside a video browsing window 1900 to a position A, video clips V1, V2, V5 and V6 which are in a select region 1902 of the mouse cursor will start to automatically play the corresponding interesting part at same time.

If the mouse 2103 moved from position A to position B as shown in FIG. 19B, the previous playing clips V1, V2, V5 and V6 will stopped, and the clips V7, V8, V11 and V12 which are now in the select region 1902 about the mouse cursor will start to play in a similar fashion.

The mouse select region 1902 can be a circle determined by adjustable radius like shown in FIGS. 19A and 19B. Alternatively, the region can be an adjustable rectangle or other determinable shape.

The selected video clips can be determined by checking whether a certain amount of the icon or thumbnail representing the video clip appears inside the select region. If predefined amount of the video clip representation appears inside the select region, the video clip will be selected for replay within the window 1900. Alternatively, the selected video can be determined by checking whether the centre of the video clip representation appears inside the region. If the centre of the video clip representation appears inside the select region, the video clip is selected. By adjusting the select region, the number of video clips whose interesting parts will be played can be changed to suit user requirements. If the select region is small enough, the result will be that a video clip will start to play its interesting part when the mouse 2103 is positioned over the video clip representation, or very close to it, and stop playing when mouse 2103 is moved away.

The arrangements of FIGS. 18 to 19B support different chosen modes for the interesting part. For each interesting part of the video clip, there may have one or more associated keywords. When a set of video clip representations has been selected, only the interesting part which has the same keyword as a user predefined keyword will start to play. In general, if there is no preferred chosen mode, i.e. no keyword been selected, all of the interesting part will be played when required. For an interesting part without keywords, such is treated as matched to any keyword. The video clip, as opposed to the interesting part, may also have associated keywords. Such a keyword associated with a video clip will apply to every interesting part of that video clip. Such means the interesting part of the video clip will have the keyword of the video clip and the keyword of the interesting part.

As shown in FIG. 20, the video clip and the interesting parts can be associated with keywords. The keywords maybe be event, name, date, place etc. For example, the video clip has the keyword “Olympic” and “park”, the interesting part A associated with “son” and “slide”, the interesting part B associated with “mum” and “bike”, the interesting part C associated with “picnic”. As the “Olympic” and “park” are keywords of the video clip, the interesting part A will effectively have keywords of “son”, “slide”, “Olympic” and “park” and interesting part B and C will effectively have keywords of the “Olympic” and “park” plus their own keywords respectively. The interesting part chosen mode maybe be set to one or a combination of those keywords. When the video clip is required to play the interesting parts, only the interesting part with matching keywords will be played.

For example, assume a clip associated with representation V1 contains interesting parts with keywords of “skin”—part A, “snow”—part B and “travel”—part A, B and C, and the clip associated with V2 contains interesting part and keywords of “swim”—part B and “travel”—part A, B, and C, and the clip of representation V5 contains “meeting”—part B and C and “work”—part A, B and C, and the clip associated is with V6 contains interested part and keyword of “work”—part A and B and “party”—part C. When the chosen mode has a keyword set to “travel”, and the mouse 2103 is at position A operating under the mouse selecting mode, then the interesting parts of video clips associated with representations V1 and V2 will start to play, but not the interesting parts associated with V5 and V6. If the chosen mode set to the keyword “skin”, only the interesting part A of the video clip associated with V1 will start to play, and rest of video clips will not be played.

It follows from the above that a video clip may be associated with a type, being a keyword or some other established identifier, and then that type may be used to identify whether or not a clip, or a particular part of a clip, is reproduced.

### INDUSTRIAL APPLICABILITY

It is apparent from the above that the arrangements described are applicable to the computer and data processing industries, and particularly for the storage and convenient retrieval of static and moving image data.

Further, whilst the arrangements above have been described with reference to hierarchical file structures, such are not essential. The arrangements may be used to provide view of any collection of data objects, of which data files are one example of data objects and hierarchical databases are one example of such a collection.

The foregoing describes only some embodiments of the present invention, and modifications and/or changes can be made thereto without departing from the scope and spirit of the invention, the embodiments being illustrative and not restrictive.

We claim:

1. A method of displaying a hierarchical file structure, said method comprising the steps of:
determining a visual arrangement of containers which reflects a hierarchical relationship of said file structure;
forming a concentric curved shape representing each said container in the file structure and files within said containers, said curved shape having a geometry and location according to the determined visual arrangement;
establishing a viewpoint for the curved shape which is substantially radial thereto and allows viewing from a root container of the file structure towards one or more child containers of the file structure; and
rendering said curved shape, relative to said viewpoint, to a display.

2. A method according to claim I wherein said determined visual arrangement and said geometry of said containers reflects a number of correspondingly contained elements.

3. A method according to claim 2 wherein said curved shape comprises at least one annulus segment, each said annulus segment representing a level in said hierarchy such that an annulus segment for a level is sectionalized according to those containers associated with said level and contained elements of a container depend from the corresponding section.

4. A method according to claim 3 wherein child annulus segments are hierarchically radially displaced relative to said viewpoint and a corresponding parent annulus segment.

5. A method according to claim 4 wherein each said annulus segment has a height, and child segments are vertically distinct from the corresponding parent segment.

6. A method according to claim 3 wherein said contained elements for a container extend from said container.

7. A method according to claim 6 wherein said contained elements extend substantially perpendicularly from said corresponding container relative to said viewpoint.

8. A method according to claim 1 where the contained elements have a visual representation and said visual representation is rendered to said display in a manner that reflects their containment within a corresponding one of the containers in the hierarchy.

9. A method according to claim 1 where the parent-child relationships in the hierarchy extend radially.

10. A method according to claim 2 where the contained elements comprise representations of photographs, video or other visual media.

11. A method according to claim 1 comprising the further steps of detecting a directional user input and altering said viewpoint relative to said curved shape according to said detected input.

12. A method according to claim 11 wherein said directional input is afforded by a pointing device such that lateral movement of said pointing device results in corresponding horizontal rotation of said curved shape relative to said viewpoint.

13. A method according to claim 11 wherein said directional input is afforded by a pointing device such that radial movement of said pointing device results in a corresponding vertical rotation of said rendered curved shape.

14. A method according to claim 1 further comprising the steps of:
(a) creating a list of images associated with one said container,
(b) forming a region,
(c) displaying the entire list of images in the region, where,
(ca) representations of said images of said list substantially fills the region, and
(cb) a size of each image represented in said region is dependent a position of the image in the region.

15. A method according to claim 14 wherein said region is 2-dimensional rectangular.

16. A method according to claim 14 wherein said region is a 3D partial surface of a cylinder.

17. A method according to claim 14 wherein images closer to one side of the region are larger than images closer to another side.

18. A method according to claim 14 wherein said region is rectangular and said images are arranged in rows such that a number of images in each said row is proportional to a corresponding row number within said region.

19. A method according to claim 14 wherein said region is rectangular and said images are arranged in rows such that a number (N) of images in each said row (n) is 2ⁿ⁻¹.

20. A method according to claim 1 further comprising the steps of:
(a) creating a list of images associated with one said container;
(b) creating a region;
(c) specifying a current position in the list of images;
(d) displaying the entire list of images in said region, where,
(da) representations of said images in said list substantially fill the region, and
(db) a size of each said image is dependent on a position of said image relative to a current position in the list of images.

21. A method according to claim 20 further comprising the steps of:
(e) detecting a user input, and
(f) altering said current position in said list according to the detected user input.

22. A method according to claim 20 further comprising the steps of:
(g) altering a size of representation of said images said altered current position.

23. A method according to claim 2 wherein said contained elements comprise video clips, each said clip being represented within said displayed file structure by a corresponding representational frame, said method further comprising the step of:
(a) determining a set of video clips selected from those represented within one said container;
(b) determining at least one interesting part of each video clip of said set;
(c) reproducing the interesting parts of each video clip in said set at the position of the corresponding representational frame of said video clip within said displayed file structure.

24. A method of displaying a collection of data objects, said method comprising the steps of:
determining a visual arrangement of containers which reflects a relationship of said data objects within said collection;
forming a concentric curved shape representing each said container, said curved shape having a geometry and location according to the determined visual arrangement;
establishing a viewpoint for the curved shape which is substantially radial thereto and allows viewing from a primary container of the collection towards one or more subsidiary containers of the collection; and
rendering said curved shape, relative to said viewpoint, to a display.

25. A method of displaying a collection of data objects, said method comprising the steps of:
determining a visual arrangement of containers which reflects a relationship of said data objects within said collection;
forming a shape representing each said container, said shape having a geometry and location according to the determined visual arrangement;
establishing a viewpoint for the shape which is allows viewing from a primary container of the collection towards one or more subsidiary containers of the collection;
forming at least one region in which a group of said data objects associated with a corresponding said container are represented; and
rendering, relative to said viewpoint, said shape with said regions extending therefrom, to a display.

26. Apparatus for displaying a hierarchical file structure, said apparatus comprising:
a processor adapted to determine a visual arrangement of containers which reflects a hierarchical relationship of said file structure;
a forming arrangement for forming a concentric curved shape representing each said container in the file structure and files within said containers, said curved shape having a geometry and location according to the determined visual arrangement;
a viewpoint establisher configured for establishing a viewpoint for the curved shape which is substantially radial thereto and allows viewing from a root container of the file structure towards one or more child containers of the file structure; and
a rendering arrangement configured to render said curved shape, relative to said viewpoint, to a display.

27. A computer readable medium having a computer program recorded thereon and executable to display a hierarchical file structure, said program comprising:
code for determining a visual arrangement of containers which reflects a hierarchical relationship of said file structure;
code for forming a concentric curved shape representing each said container in the file structure and files within said containers, said curved shape having a geometry and location according to the determined visual arrangement;
code for establishing a viewpoint for the curved shape which is substantially radial thereto and allows viewing from a root container of the file structure towards one or more child containers of the file structure; and
code for rendering said curved shape, relative to said viewpoint, to a display.
